(19) United States
(12) Patent Application Publication
(10) Pub. No.: US 2009/0017789 A1
(43) Pub. Date: Jan. 15, 2009

(54) Point of presence on a mobile network

(75) Inventors: Hugh W. Thomas, Chapel Hill, NC (US); Michael John Linstrom, Fort Worth, TX (US); Antti Juhani Raina, Lantana, TX (US); Jun Xu, Irving, TX (US); Frank Andrew Smoak, Cary, NC (US); Kevin Martin Asbury, Irving, TX (US); William Henze, III, Irving, TX (US); Darrin Jesse Bates, Durham, NC (US); Steven E. Cistulli, Duluth, GA (US)

Correspondence Address: ROBERT PLATT BELL;REGISTERED PATENT ATTORNEY, P.O. BOX 13165, Jekyll Island, GA, 31527, US

(73) Assignee: TapRoot Systems, Inc., Morrisville, NC (US)

(21) Appl. No.: 12/011,025

(22) Filed: Jan. 22, 2008

Related U.S. Application Data
(60) Provisional application No. 60/881,296, filed on Jan. 19, 2007.

(51) Int. Cl. H04M 11/00

(52) U.S. Cl. 455/406

(57) ABSTRACT

A wireless device with a capacity for high bandwidth connectivity adapted to provide access to the Internet or other WAN for a single user or multiple concurrent users. The wireless access device acts as a network point of presence to provide access to a number of different devices. Authorization is performed and billing measures are established in real time. Billing credits may be provided to an account associated with the user of the wireless access device based upon selected metrics (for example, duration of the connection or amount of data passed). In certain implementations, devices that are previously unknown to the wireless access device and that have not received a wireless access device-specific configuration can be provided network access. Thus, instead of a hard-wired point of presence to the Internet, a mobile, ad hoc point of presence is established through the wireless access device.

This application claims priority to and incorporates by reference herein, U.S. Provisional Application Ser. No. 60/881,296, filed on Jan. 19, 2007, with title “Software Based Access Point on Cellular Device.”

### BACKGROUND

### Field of the Disclosure

This disclosure relates generally to computer networks including computer networks with wireless access points that connect indirectly to a wide area network such as the Internet. More particularly, the disclosure relates to establishing an ad hoc point of presence on a wireless network with, in one embodiment, a wireless device.

Conventional solutions in this field have provided solutions to allow connectivity of a variety of devices, such as laptops, to a wide area network, such as the Internet. Such devices may be considered clients of the network.

One conventional solution is the so called Wireless Internet Service Provider (“WISP” or “wireless ISP”). A number of devices with wireless access such as laptop computers with wireless modems integrated into the laptop or attached to the laptop can access a wireless local access network. Examples of such installations can be found in airports, hotels, and coffee shops. The mobile computation device, such as a laptop, cannot connect directly to the Wide Area Network (“WAN”), but does so by being granted access (often for a fee or as part of the amenities for the rental of a room in a hotel) to a wireless modem that is, in turn, a wired connection to the Internet through an Internet service provider.

While this solution is convenient in some ways, it may require a service agreement with the local wireless access provider such as the airport, hotel, or coffee shop. A new access point must be found each time the laptop is moved to new position and there are only a very small number of WISP sites. Important characteristics of these WISPs are that they are in a fixed location (as opposed to being mobile) and there are relatively few WISP sites given the immense size of the United States or other countries with significant numbers of user devices.

A second conventional solution is to carry an Internet enabled cellular device and to configure both the wireless device and the user's laptop to allow the laptop to access the Internet through the wireless device. One example is that a laptop may use a short range single-user wireless communication protocol such as Bluetooth. While this allows the laptop to access the Internet from anywhere that the wireless device has an adequate cell signal, there are disadvantages to this solution. First, the laptop needs a short range wireless communication capability such a Bluetooth. While the vast majority of devices such as laptops have Wi-Fi modems, only a small percentage have Bluetooth connections or other short range wireless technologies (e.g., infrared). Second, the solution requires someone with some level of skill to set up the connection between the laptop and the wireless device. Third, some short range wireless technologies, such as Bluetooth, offer limited connectivity options (e.g., generally point-to-point connections), limited transmission distance and power (e.g., close, unobstructed line-of-sight communication with a laptop), and insufficient bandwidth for high speed data connections.

A variant on the latter solution is to obtain a separate wireless modem Internet access card for the laptop which is essentially a limited purpose wireless device that provides Internet access to the laptop through a dedicated wireless device number. Again this, solution is inefficient to the extent that it requires each laptop user to acquire such hardware and service agreements even if the laptop will only infrequently use this method of Internet access for a single user.

Thus while the conventional solutions have provided: A) hardwired WISP connections that allow a number of laptops to connect through the WISP, and B) cellular devices with the special capacity to provide Internet access to connect a single laptop to the Internet with the cellular device in the capacity of a client of a remote server wired to the Internet, another option is needed in order to overcome the limitations of prior solutions.

### SUMMARY

A wireless device with a capacity for high bandwidth connectivity, such as a cell phone, satellite phone, or other wireless device, provides access to the Internet or other WAN for a single user or multiple concurrent users. The high bandwidth wireless device is adapted to act as a network point of presence and provide access to a number of client computing devices, such as laptops, GPS devices, music download devices, etc. Authorization is performed and billing measures are established in real time and billing credits are provided to an account associated with the user of the wireless device based upon the duration of access to the network by the client computing device. In certain implementations, client computing devices that are previously unknown to the wireless device and that have not received a wireless device-specific configuration are provided network access. Thus, instead of a hard-wired point of presence to the Internet, the point of presence is the enabled wireless device.

### BRIEF DESCRIPTION OF THE FIGURES

The disclosure can be better understood with reference to the following figures. The components in the figures are not necessarily to scale, emphasis instead being placed upon illustrating the principles of the disclosure. Moreover, in the figures, like reference numerals designate corresponding parts throughout the different views.

FIG. 1 illustrates an exemplary network environment according to an implementation of the subject matter described herein;

FIG. 2 illustrates that software running on a wireless device enables the distribution of the data services offered by a cellular network to be distributed in local area networks (LANs) or small area networks supported by 802.11 and analogous WLAN technologies supported on the wireless device;

FIG. 3 illustrates an exemplary block diagram of a wireless device that is enabled to provide services to a client computing device;

FIG. 4 illustrates an exemplary block diagram of a server that is enabled to provide services in conjunction with a wireless device to a client computing device;

FIG. 5 illustrates an exemplary implementation where a single wireless device is provided with a user interface to allow or disallow access to an Internet connection computing devices that are within range of the wireless device;

FIG. 6 illustrates an exemplary implementation of access to the Internet through a population of mobile points of presence for devices that are not previously known to the wireless device;

FIG. 7 illustrates an exemplary message flow between a wireless device and a server to configure the wireless device for operation and between those devices and a computing device to authorize the computing device for operation;

FIG. 8 illustrates an exemplary authentication message flow between a computing device, a wireless device, and a server for authentication of a computing device to operate upon the network;

FIG. 9 illustrates an exemplary user interface screen for a wireless device that provides connection information for the wireless device;

FIG. 10 illustrates an additional exemplary user interface for a wireless device that provides additional connection information for the wireless device;

FIG. 11 illustrates an exemplary process for providing mobile network access; and

FIG. 12 illustrates an alternative exemplary network environment according to an implementation of the subject matter described herein.

### DETAILED DESCRIPTION

A wireless device with a capacity for high bandwidth connectivity, such as a cell phone, satellite phone, or other wireless device, provides access to the Internet or other WAN for a single user or multiple concurrent users. The high bandwidth wireless device is adapted to act as a network point of presence and provide access to a number of client computing devices, such as laptops, GPS devices, music download devices, etc. Authorization is performed and billing measures are established in real time and billing credits are provided to an account associated with the user of the wireless device based upon the duration of access to the network by the client computing device. In certain implementations, client computing devices that are previously unknown to the wireless device and that have not received a wireless device-specific configuration are provided network access. Thus, instead of a hard-wired point of presence to the Internet, the point of presence is the enabled wireless device. For purposes of the present description, real time includes any time frame fast enough to provide a targeted level of service without interfering with a desired operation by imposing a lag that would not be tolerated by the system or by the user of the system.

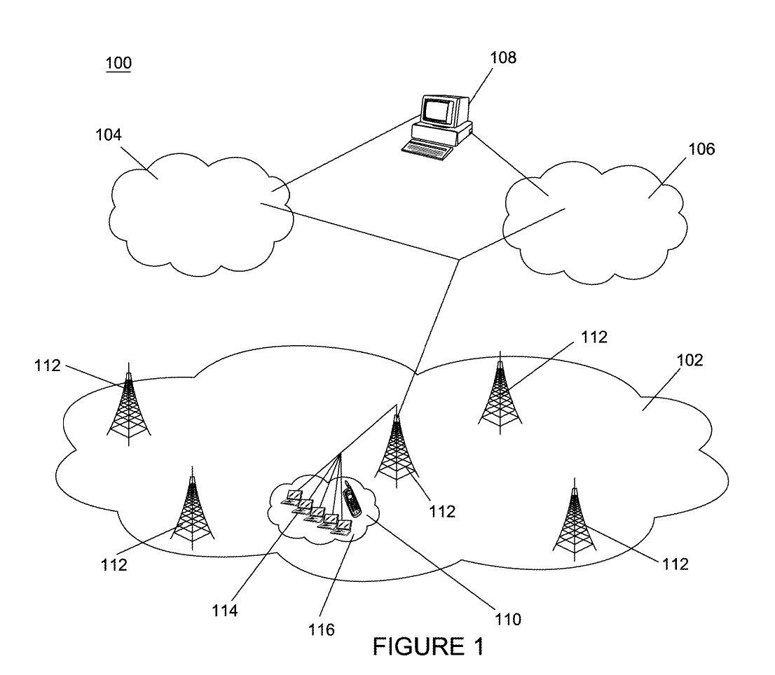

FIG. 1 illustrates an exemplary network environment 100 according to an implementation of the subject matter described herein. FIG. 1 provides an overview of the environment in which the current disclosure may operate. The three clouds represent three distinct networks. The cellular (telephone) network 102 connects via an Internet 104 connection and/or a PSTN (Public Switched Telephone Network also known as the telephone network) 106 connection to a server 108. The server 108 provides server-side communications as will be described in more detail below.

The cellular network 102 provides voice and data services to a wireless device 110 via wireless signals, such as wireless signals based on well established world wide standard transmission formats (e.g., GSM, CDMA, W-CDMA, UMTS, WiMAX, etc.) or any other wireless signals, from wireless base stations, cellular towers, or controllers 112 (collectively cell towers 112 within this description) within a certain geographic radius (typically 3-30 miles). The wireless device 110 interacts with the cellular network 102 via licensed frequencies purchased and owned by particular wireless service providers (e.g., privately owned frequency band) to provide a network point of presence. In addition to providing voice services, the wireless device 110 is also capable of providing data services to client computing devices 114 via a shorter range wireless local area network (WLAN) 116. The WLAN 116 may use any suitable wireless protocol, such as 802.11 WLAN. This latter communication protocol is in the frequency spectrum allocated for this use but not owned by any one company (e.g., public non-licensed frequency spectrum). The communication is bidirectional and data services are provided seamlessly via the wireless device 110 to the user of the client computing devices 114. The wireless device 110 performs services such as network address translation (NAT), dynamic host configuration protocol (DHCP) server, mobile gateway and mobile router services.

The client computing devices 114 may be any type of computing device having a radio frequency (RF) interface that is compatible with a RF interface operating on the wireless device 110. Accordingly, the client computing devices 114 include devices such as desktop computers, laptops, or any other devices that may request specific data from a network and benefit from receipt of that data. It should be noted that any device that utilizes data retrievable from a remote source is considered within the scope of the computing device 114. As additional examples of devices that fall within the scope of the client computing devices 114, personal digital assistants (PDAs), cellular phones with Wi-Fi capability, global positioning system (GPS) devices, certain gaming devices, and music downloading devices also fall within the scope of the client computing devices 114, as do any other devices that utilize remotely accessible data.

As will be described in more detail below, the wireless device 110 and the server 108, along with the WLAN 116, form an integrated networking capability for the client computing devices 114. Accordingly, the server 108, wireless device 110, and WLAN 116 form an infrastructure to support the client computing devices 114 for high-speed networking capabilities with on-the-fly configurability and real-time setup and tear down of network connections to create a dynamic, secure, and flexible networking environment. The wireless device 110 forms a mobile, ad hoc point of presence within the cellular network for the client computing devices 114.

As referenced above, the conventional solutions included the ability of the cellular device and the laptop to be configured so that the cellular device served as an external modem to connect that laptop to the Internet rather than having a wireless cellular card inserted into the laptop. While the connection may have been over a short range wireless connection such as Bluetooth, the laptop and cellular device were tightly coupled to work together prohibiting looser relationships, including use of the cellular device by a laptop that was previously unknown to the cellular device. The tightly coupled relationship also precluded the concurrent use of a cellular device by more than one laptop at a time as Bluetooth is typically a point-to-point connection.

Teachings of the present disclosure overcomes these limitations and provides for high-speed networking capabilities with on-the-fly configurability and real-time setup and tear down of network connections to create a dynamic, secure, and flexible networking environment.

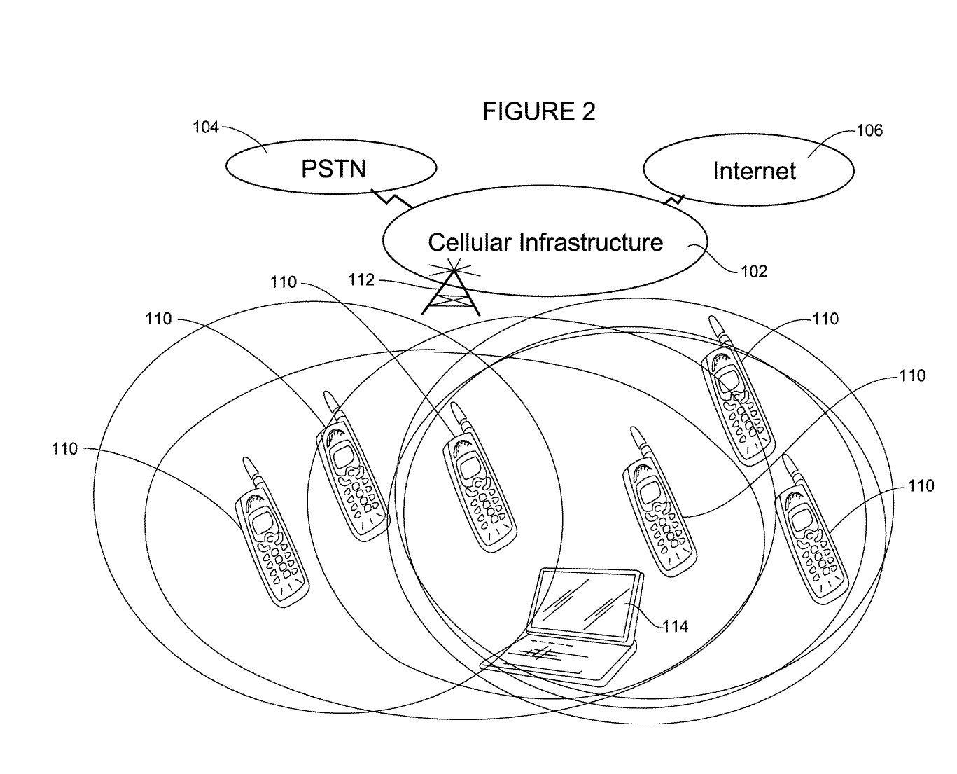

FIG. 2 illustrates that software running on the wireless device 110 enables the distribution of the data services offered by the cellular network 102 to be distributed in local area networks (LAN) or small area networks supported by 802.11 and analogous WLAN technologies supported on the wireless device 110.

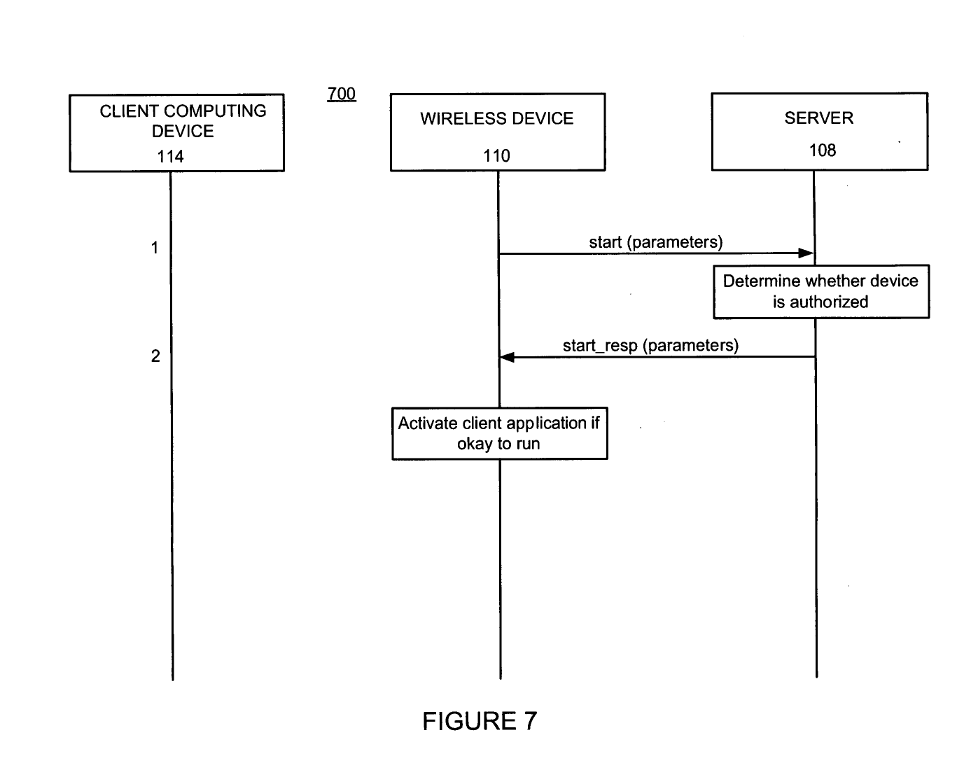

The transfer of data from the privately owned cellular networks to a “publicly” owned frequency spectrum offers the possibility of re-distribution of the services to a new customer base and not just “private” clients of a particular cellular infrastructure network (e.g., Verizon® or AT&T®). Thus each wireless device 110 that is connected over a private frequency band to the cellular network 102 becomes a potential mobile wireless point of presence over the public frequency band for multiple users. As described above, the multiple users are considered clients and their client computing devices 114 may be rapidly configured for networking capabilities via signaling interaction with the wireless device 110. Details of this signaling will be described in more detail below beginning with FIG. 7.

It should be noted that the wireless device 110 may utilize any cellular data network technology (e.g., 2.5G, 3G, 4G, or any future technology). Additionally, because different wireless carriers have different wireless data standards for bandwidth at the cell towers 112, different bandwidth may be available via different wireless devices 110 within range of a given client computing device 114. Accordingly, a client computing device 114 using a Wi-Fi or other link may choose among different wireless devices 110 based upon available signal strength and bandwidth capacities of the respective wireless devices 110. Thus, use of Wi-Fi or an analogous communication protocol may allow greater redundancy than conventional solutions of using a private Bluetooth link to a specific cellular device connected to a specific cellular service provider.

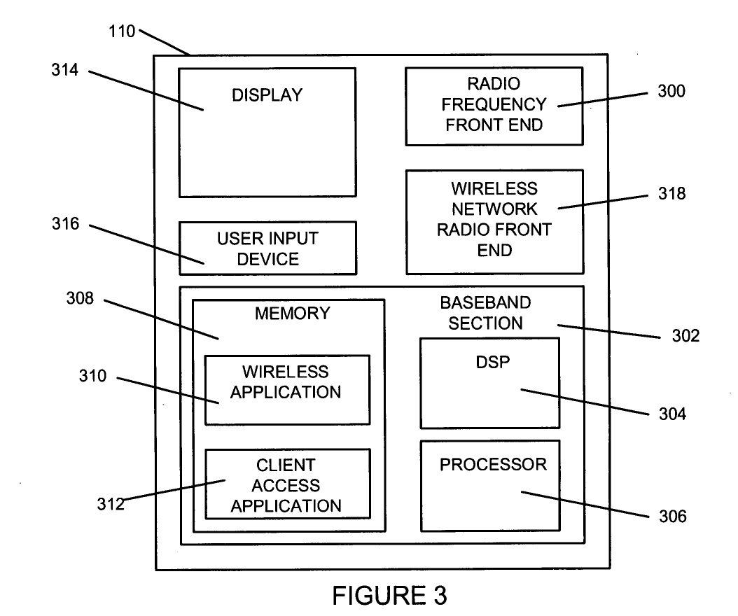

FIG. 3 illustrates an exemplary block diagram of the wireless device 110 that is enabled to provide services to a client computing device 114. As can be seen from FIG. 3, the wireless device 110 includes a radio frequency front-end 300. The radio frequency front-end 300 provides radio frequency (RF) control and signaling capabilities for bi-directional communication for the wireless device 110. A baseband section 302 provides core functionality and signal processing for the wireless device 110. A DSP 304 converts the signal from analog to digital (or from digital to analog) and modulates and demodulates data in order to process signaling received from or transmitted to the RF front-end 300. A processor 306 provides computational and processing capabilities for the wireless device 110 and includes signal processing capabilities to perform signal and channel correlations. A memory 308 provides data storage (not shown) and executable code space (not shown) capabilities for the wireless device 110. The memory 308 is illustrated as a single component within FIG. 3. However, it is understood that the memory 308 may include multiple components usable for different purposes. For example, the memory 308 may include random access memory (RAM), read-only memory (ROM), non-volatile memory, or memory components, including bulk devices such as a hard drive, without departure from the scope of the subject matter described herein.

The memory 308 includes a wireless application 310 that performs application-level processing for wireless activities within the wireless device 110. A client access application 312 can provide application-level point of presence capabilities within the wireless device 110, as will be described in more detail below. The client access application 312 may operate on any operating system that is capable of operation on a mobile platform. A display 314 provides user output capabilities and a user input device 316 provides the user of the wireless device 110 with input capabilities for interaction with the wireless device 110. A wireless network radio front end 318 provides communication capabilities for the wireless device 110.

The wireless device 110 is enabled via the client access application 312 running on the wireless device 110. The client access application 312 may be added at the creation of the wireless device 110 or in other instances may be a downloadable addition to an existing wireless device 110 already deployed in the market.

Subject to certain hardware requirements, the functionality may be implemented so as to be device independent and support multiple operating systems such as Microsoft®, Symbian®, and Linux®, or any other embedded operating systems. It is understood that there are many possible embedded or other operating systems upon which the functionality described herein may be implemented. Accordingly, use of any such embedded or other operating systems is considered within the scope of the subject matter described herein.

The wireless device 110 provides port translation, such as network address translation (NAT) and NAT routing to allow the client computing devices 114 to connect to the wireless device 110 and shares an Internet Protocol (IP) address that is issued by the cellular carrier ultimately culminating in a shared connection carried via the Internet 104. Additionally, the wireless device 110 also performs server-type activities, such as acting as a dynamic host configuration protocol (DHCP) server. As such, the wireless device 110 is also capable of creating and assigning a separate IP address to each client computing devices 114 within the WLAN 116.

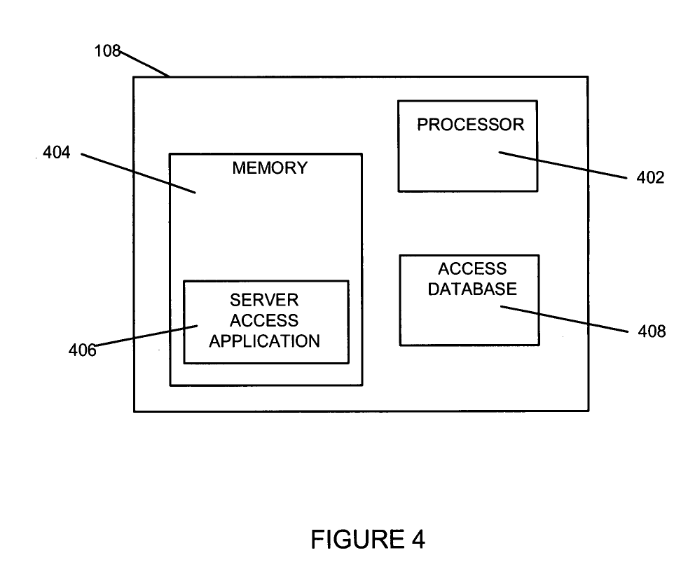

FIG. 4 illustrates an exemplary block diagram of the server 108 that is enabled to provide services in conjunction with the wireless device 110 to a client computing device 114. As can be seen from FIG. 4, the server 108 includes processor 402 that provides computational and processing capabilities for the server 108. A memory 404 provides data storage (not shown) and executable code space (not shown) capabilities for the server 108. The memory 404 is illustrated as a single component within FIG. 4. However, it is understood that the memory 404 may include multiple components usable for different purposes. For example, the memory 404 may include random access memory (RAM), read-only memory (ROM), non-volatile memory, or memory components, including bulk devices such as a hard drive or a removable flash memory card, without departure from the scope of the subject matter described herein.

The memory 404 includes a server access application 406 that provides application-level capabilities within the server 108, as will be described in more detail below. The server access application 406 may operate on any operating system that is capable of operation on a server. The client access application 312 may operate on any operating system that is capable of operation on a mobile platform. An access database 408 provides storage and other capabilities for the server 108.

The server 108 provides authentication at run time or at other times and provides user account administration and logging. Communication between the wireless device 110 and the server 108 is transparent to a user of either the wireless device 110 or the client computing device 114. When the user of the wireless device 110 starts the client access application 312, the wireless device 110 connects to the server 108 for validation utilizing IP messaging such as hypertext transfer protocol (HTTP) or secure HTTP (HTTPS). As client computing devices 114 are added, the wireless device 110 checks its local table to see if the media access control (MAC) address of the specific client computing device 114 is known. If the MAC address for the client computing device 114 is not known, it is queried from or added to the access database 408 after the owner of the wireless device 110 grants access to the client computing devices 114.

The architecture of the server 108 is scalable. The scalable nature of the server 108 allows the server 108 to be expanded by adding additional computing capabilities at the server level. For example, additional processing power, such as an additional processor 402, or additional database storage, such as the access database 408, may be added without departure from the scope of the subject matter described herein. As such, load balancing may be performed by the server 108 via this set of computing facilities. These computing facilities may be organized in clusters (not shown) and each cluster may implement and run a monitoring component for determining and analyzing load balancing and related functions. Subsystems and components for processors, memory, disks, event logs, message queues, processes, jobs, network interfaces, and statistics associated with these devices may all be monitored. Scheduled upgrades for the current version of the client access applications 312 running throughout the network and for the server access applications 406 may be scheduled and performed.

Firewall (not shown) and virtual private network (VPN) (not shown) services may also be configured to operate on either the wireless device 110 or the server 108. Data protection (not shown) via system back-ups may also be performed. Intrusion detection devices (not shown) may also be provided for increased protection against unauthorized system access.

Logging features may include system access logging, tracking, and auditing. Additionally, password encryption, disaster recovery plans, and maintenance and change management may all be provided. Multiple languages may be supported by interfaces at both the wireless device 110 and the server 108.

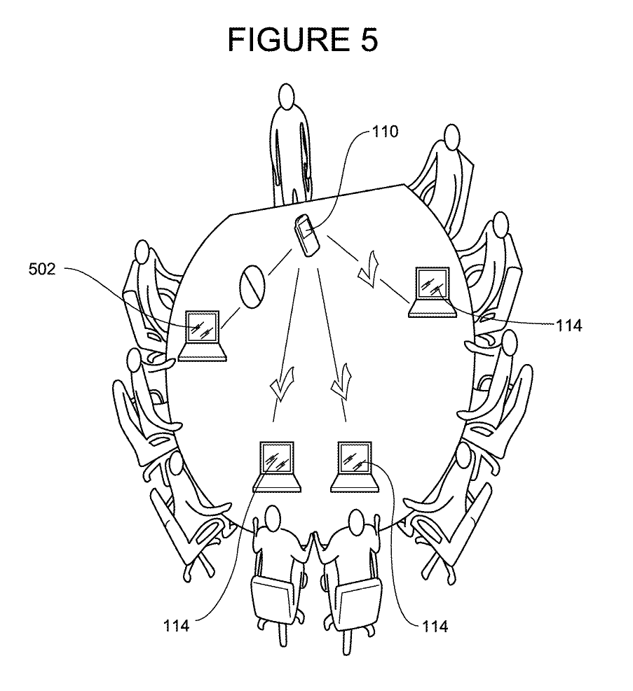

FIG. 5 illustrates an exemplary implementation 500 where a single wireless device 110 is provided with a user interface to allow or disallow access to a connection via the Internet 104 by computing devices that are within range of the wireless device 110. Within FIG. 5, three of the computing devices have been approved to use the wireless device 110 as client computing devices 114. An additional computing device 502 is not authorized to use the wireless device 110 for networking activities.

An example of where this might be useful is a company that frequently sends sales teams to meet with customers and to learn about customer needs, make sales pitches for future projects, or discuss status or customer concerns about current projects.

By programming the wireless device 110 to accept computer traffic from a select number of client computing devices 114, the members of the sales team may share the one high-bandwidth connection via the wireless device 110. Authorization of computer traffic from the client computing devices 114 may be performed by any one of a number of methods of identifying eligible computing devices. Examples include, but are not limited to, the use of plug in keys; an identified parameter of the computing device such as MAC ID; a WEP key coded into the laptop to provide access to the particular wireless device 110; and software keys loaded on the client computing device 114. Alternatively, the request to use the wireless device 110 may appear on the display 314 on the wireless device 110 along with some identifier, such as the service set identifier (SSID) or MAC address of the client computing device 114 that is attempting to seek authorization to use the ad hoc point of presence capabilities of the wireless device 110. The user of the wireless device 110 may accept or deny the request to access the Internet 104 through the wireless device 110. So that the response time for the business of the sales team is maximized, others, not part of the sales team, would not be able to access the bandwidth into or out of the wireless device 110.

The limitation of access may be implemented in a number of ways including the use of the 802.1x standard used in connection with 802.11 wireless networks. A user laptop seeking to access the wireless device 110 for access to the Internet 104 would request access and would start as an unauthorized user that can simply request authorization such as with an extensible authentication protocol (EAP) start message. The implementation may be set up to authenticate users at the wireless device 110 or to forward the request for authentication from the wireless device 110 point of presence to the server 108. As such, in addition to performing networking capabilities, the server 108 may also act as an authentication server. Once authenticated, the client computing device 114 is allowed to communicate normal traffic through the wireless device 110 to reach a network, such as the Internet 104, or to access information on the server 108.

The concept illustrated above in connection with the sales team could be implemented instead at a home or small business. Rather than having a cable modem, wireless hub/router and service agreement with a service provider for data, a home-based system could use a wireless device 110 with a high bandwidth connection out to the cellular network 102. Computing devices within the household could be authorized as client computing devices 114 and listed as enabled users of the wireless device 110, as described above.

As is done in connection with conventional wired access points, to avoid having the bandwidth resources tapped by neighbors, unauthorized users could be prevented from communicating or receiving normal traffic across the wireless device 110. This may be implemented by using secure Wired Equivalent Privacy/Wi-Fi Protected Access (WEP/WPA) connections which may require some level of user setup to install settings on the devices to be connected. In this way, a computer of a neighboring computer user that is within range of the wireless device 110 may be prevented from gaining access to the high-speed networking capabilities of the wireless device 110 because it would not be authorized to access the wireless device 110.

When the owner of the wireless device 110 leaves the home with the wireless device 110, access to the Internet 104 is stopped for any authorized and active client computing devices 114. This feature provides parents that want to limit their children's unsupervised access to the Internet 104 with a capability to physically remove any connection to the Internet 104 when they leave.

For home use this connection could replace a wired cable connection or an ASDL modem. For a small business, this broadband level connection through the wireless device 110 could replace a leased T1 or E1 line.

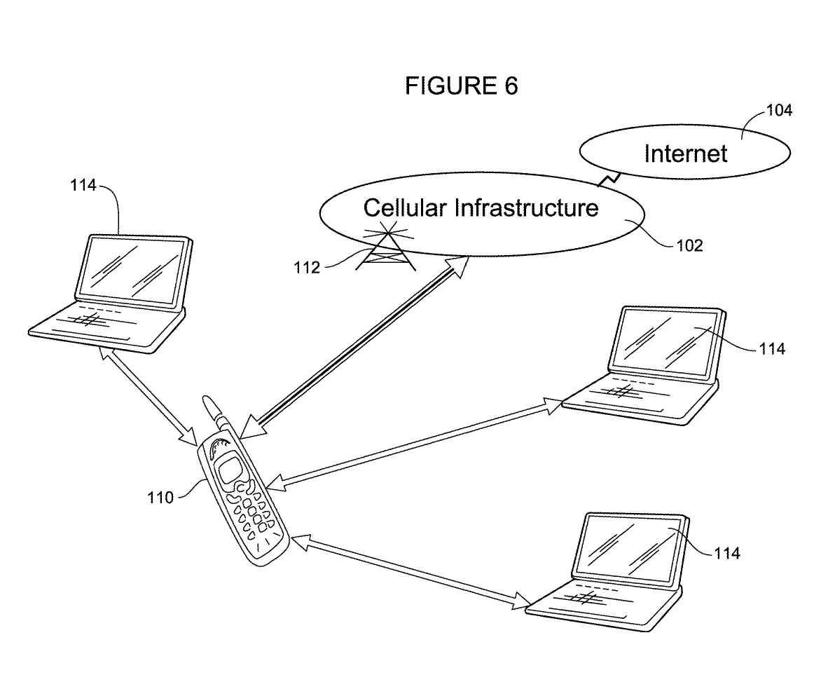

FIG. 6 illustrates an exemplary implementation 600 of access to the Internet 104 through a population of mobile points of presence for devices that are not previously known to the wireless device 110. Population of mobile points of presence may be used to allow some or all of their bandwidth to be used by “strangers,” that is, devices belonging to users not necessarily known by the user of the wireless device 110. A stranger seeking to access the Internet 104 would initiate a request to connect to the Internet 104, then would be passed through an available wireless device 110 within wireless communication range of the user's client computing device 114 and authenticated to provide access. Rather than the authentication being performed by the wireless device 110, the authentication could be performed by a service provider that provides wireless service to the wireless device 110. Alternatively, a service provider with which the stranger has an account may be contacted separately by the stranger for account authorization and the stranger may provide identifying information for the wireless device 110 that it wants to connect through and the service provider may initiate authentication with the wireless device 110. Many other approaches to authentication for a stranger are possible and all are considered within the scope of the subject matter described herein.

The user of the client computing device 114 may receive a served web page (such as DHCP/HTML) and provide authentication credentials such as, but not limited to, credit card information or stranger's cellular phone number, surname, home billing address, and Personal Identification Number (PIN). These credentials may be passed to the service provider and after authentication is provided to the wireless device 110, the user of the client computing device 114 may be configured as a client computing device 114 with the ability to send and receive normal traffic via the Internet 104.

The user (or someone with a relationship with the user, such as the user's employer or user's parent) would have a financial relationship with the service provider. The usage may be metered based on some combination of the time duration of connection, number and size of packets sent or received, or other factors (such as peak or off-peak usage, or elevated quality of service requirements such as may be required for latency sensitive applications). As with any service, some service providers may opt to provide an unlimited usage plan.

A token based “reward” incentive plan may be implemented. Under such a plan, the subscriber of the wireless device 110 could be incentivized by the wireless carrier to make this service available via a rewards incentive plan. A revenue sharing plan based on the metered use of time and/or data passing through the wireless device 110 could be offered to the subscriber. For example, for every new connection session a payment could be credited to the user. Alternatively, a certain amount of money may be credited to an account associated with the user of the wireless device 110 based upon a quantity of data (e.g., per megabyte) passing through the wireless device 110.

In order to provide an incentive for the user/owner of the wireless device 110 to provide access to unknown third parties through the wireless device 110, there needs to be a mechanism for the user/owner of the wireless device 110 to be compensated in excess of the service charges the user/owner is accruing while providing access to the third party users. Another “cost” to the user of the wireless device 110 for providing access to the Internet 104 for third parties through the wireless device 110 is that the extra activities provide additional consumption (“drain”) of the charge stored on the batteries of the wireless device 110. Thus, without incentives, a person with even unlimited access to the Internet 104 would prefer not to grant access to third parties.

FIG. 7 illustrates an exemplary message flow 700 between the wireless device 110 and the server 108 to configure the wireless device 110 for operation and to authorize the client computing device 114 for operation. The message flows within FIG. 7 are represented in extensible markup language (XML) format, though this should not be considered a limitation because any message format may be used.

When the user of the wireless device 110 starts the client access application 312, a start message is sent from the wireless device 110 to the server 108 (line 1). The start message includes parameters, such as message type, phone international mobile equipment identification (IMEI), cell identifier, software version, and comments. Other parameters are also possible.

In response to receipt of the start message, the server 108 determines whether the requesting wireless device 110 is authorized to operate within the network. In response to determining whether the wireless device 110 is authorized, the server 108 sends a start response message (line 2) to the requesting wireless device 110. The start response message includes parameters such as message type, response (e.g., okay to run or never start), service level, date, random identifier (e.g., to match with a subsequent stop message as discussed below), number of available IP addresses, base IP address, lease time, short lease time, new software version, data amount remaining, byte count on/off, port restriction on/off, and notes.

In response to receiving the start response message, the wireless device 110 will either start the client access application 312 or will stop its attempts depending upon whether the parameter set indicated that it was okay to run or whether it should never start.

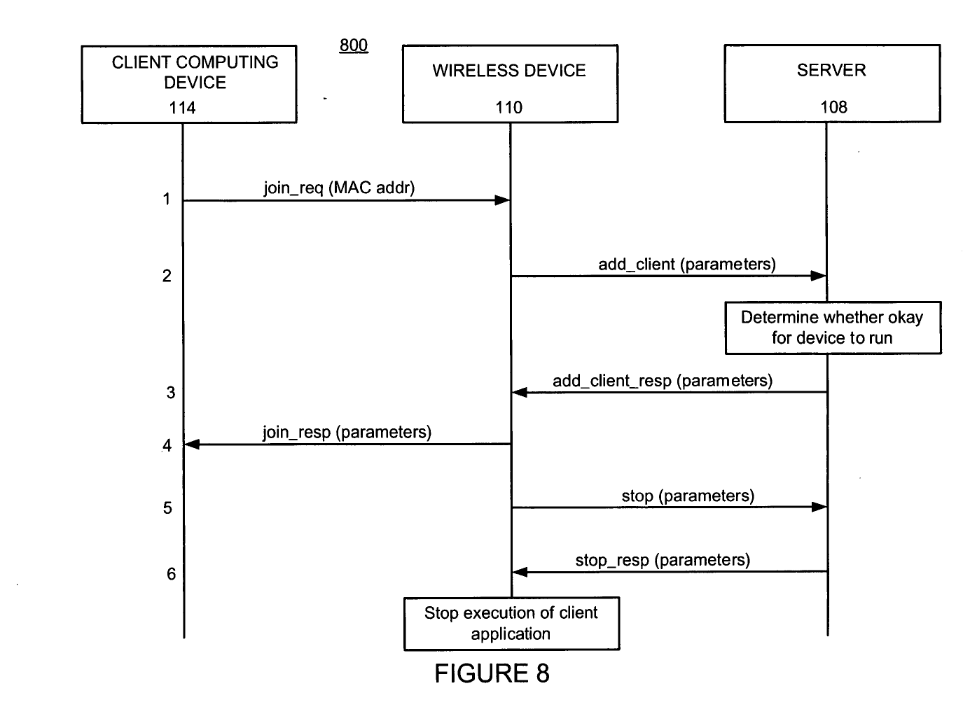

FIG. 8 illustrates an exemplary authentication message flow 800 between the client computing device 114, the wireless device 110, and the server 108 for authentication of the client computing device 114 to operate upon the network. FIG. 8 sets forth just one set of generalized steps for establishing a session where the request for access through the wireless device 110 is processed at the wireless device 110.

The authentication is initiated by the client computing device 114 sending a join request for access to the Internet 104 to the wireless device 110 (line 1). The client computing device 114 may include its MAC address or other identifier as a parameter. In response to receipt of the join request for access to the Internet 104, the wireless device 110 sends an add client message to the server 108 (line 2). The add client message parameters may include a message type, phone IMEI, MAC address of the new device, cell ID, software version, and comments). Additional add client message parameters are possible. For example, identification information associated with a billing account for the client computing device 114 may be sent to the server 108 to allow billing for data services.

In response to receipt of the add client message, the server 108 determines whether it is appropriate for the proposed device to run. Many options are possible for determining whether the proposed device should be authorized to run. For example, the server 108 may determine whether it is appropriate for the proposed device to run based upon whether identification information associated with a billing account for the device has been received. The server 108 sends an add client response message to the wireless device 110 in response to it's determination about whether the client computing device 114 is to be allowed to run (line 3). A parameter for the add client response message includes a message type indicating whether the device is authorized to run. For ease of illustration, it will be assumed that the client computing device 114 is authorized to run. In this instance, the wireless device 110 sends a join response message to the client computing device 114 (line 4). Parameters for the join response message may include an IP address and a lease time.

It should be noted that multiple client computing devices 114 may join during an active session of the client access application 312. When the last client computing device 114 terminates its communications through the wireless device 110, the session may be considered completed.

When the user of the wireless device 110 stops the client access application 312, the wireless device 110 sends a stop message to the server 108 (line 5). Parameters for the stop message may include a message type, phone IMEI, received data, sent data, and cell identifier. In response to receipt of the stop message, the server 108 sends a stop response message to the wireless device 110 to terminate the session (line 6). Parameters for the stop response message include a message type and a response (e.g., ok to continue). Upon receipt of the stop response message, the wireless device 110 terminates execution of the client access application 312. All pertinent data metrics of the session are also uploaded to the server 108 for permanent or semi-permanent storage.

As described above, FIGS. 7 and 8 illustrate an exemplary authentication operation for the wireless device 110 and an exemplary session, respectively. It should be understood that while these figures depict exemplary signaling, any signaling appropriate for a given platform, such as XML, may be used to implement these communications and message flows. Additionally, for example, universal access method (UAM)-based UAM/802.1X negation may be performed for authentication within without departure from the scope of the subject matter described.

By automating the message flows, some implementations may be created that do not require user training to access a wireless device 110 from a client computing device 114 and do not require any specific modifications to the client computing device 114 settings in order to access the one particular wireless device 110 versus another similar wireless device 110.

Several user configuration settings are provided for the wireless device 110. For example, these user configurations settings include wide area network (WAN) access point, Wi-Fi settings, power management, client auto-connection capabilities, automatic shutdown features, and restoration of settings upon reconnection or power up. Many other configuration options are possible and all are considered within the scope of the subject matter described.

Several system features may also provided for the wireless device 110. For example, these system features include account creation, sign-in, authentication, and a number of concurrent users that may be configured. The number of concurrent users may also be controlled by the server 108 based upon a “service level” for the client access application 312 operating within the wireless device 110.

Several security features may also be provided for the wireless device 110. For example, these security features may include: ensuring that only valid client computing devices 114 may connect to the wireless device 110; utilization of Wi-Fi security settings from the wireless device 110; access restrictions based upon MAC address; roaming awareness and management; and power management.

The roaming management function may be performed to run on top of the WAN transport supplied by a given carrier and is controlled by standard subscriber identification module (SIM) authentication. Additionally, data plans may be provided by which a user may include roaming within the plan coverage.

The power management function may include features such as automatic shutdown during idle periods, WAN restarts when traffic from client computing devices 114 occurs, and automated shutdown based upon battery usage.

Additional information that may be provided to a user of the wireless device 110 is version information for the client access application 312, the number of active connections, an ability to push messages to the user at application startup, enabling or disabling server-based control of the wireless device 110 from the server 108 (e.g., user enabling and disabling, and service level changes), and capabilities to collect model information (e.g., such as by performing data logging and cell tower information gathering).

Additionally, a web site may be hosted on the server 108 for account creation and management. A user of the wireless device 110 may enter the web site and supply information (e.g., name, email address, and phone number) so the client access application 312 may be provisioned to configure and enable the point of presence on a wireless network with, in one embodiment, a wireless device.

Authentication and provisioning may further be enhanced by providing a variety of options. For example, a user may visit a web site, as described above for account setup, and request to download the client access application 312 to the wireless device 110. Alternatively, the user may select to download the client access application 312 to a separate computing device and then upload that the client access application 312 to the wireless device 110. The user may also enter a mobile number in a web site dialog session and receive a short message service (SMS) message that includes a hypertext link, or other link, to a server address through which the client access application 312 may be downloaded.

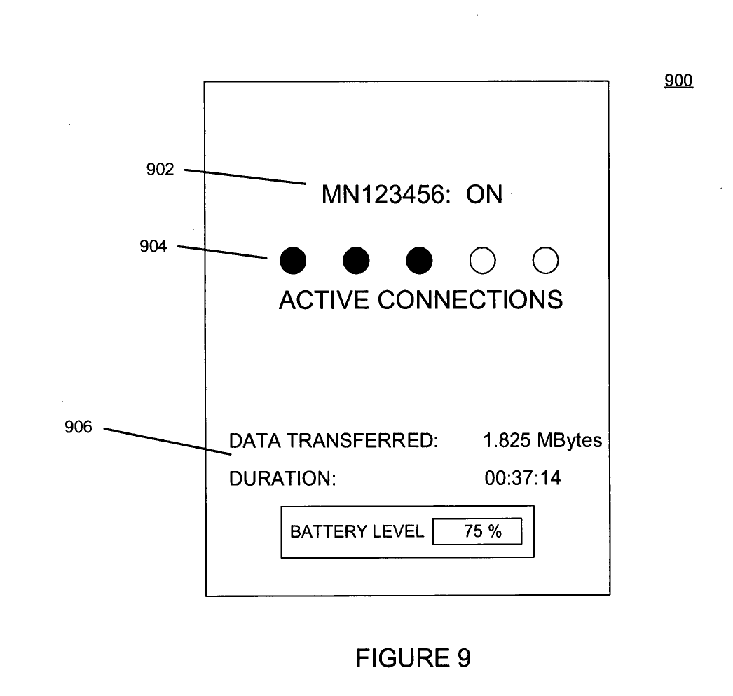

FIG. 9 illustrates an exemplary user interface screen 900 for the wireless device 110 that provides connection information for the wireless device 110. An activation status section 902 indicates whether the client access application 312 is on or off, and is illustrated to be on within FIG. 9. An active connections section 904 provides connection information for the wireless device 110. As can be seen from FIG. 9, three connections are active on the wireless device 110. An information section 906 provides detailed information, such as transferred data quantities, duration of the present session, and battery level. There are many other possible parameters and information that may be presented on the user interface screen 900 and all are considered within the scope of the subject matter described herein. For example, a roaming notification, a startup or shutdown message display sequence, data limitations based upon service level agreement, and battery status indications may all be presented on the user interface 1000. The battery status indications may further include battery rate consumption.

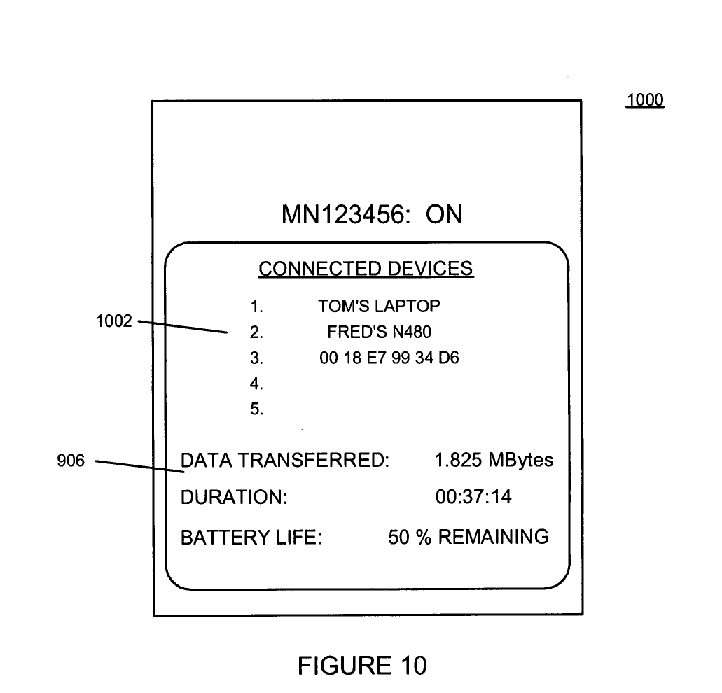

FIG. 10 illustrates an additional exemplary user interface screen 1000 for the wireless device 110 that provides additional connection information for the wireless device 110. A connection detail section 1002 indicates device names, MAC addresses, or other identifying information for the connected client computing devices 114. As with FIG. 9, FIG. 10 illustrates that three connections are active on the wireless device 110. The information section 906 is repeated and provides detailed information, such as transferred data quantities, duration of the present session, and battery level. There are many other possible parameters and information that may be presented on the user interface screen 1000 and all are considered within the scope of the subject matter described herein. For example, billing information may be provided on the user interface screen 1000 without departure from the scope of the subject matter described herein.

Additionally, direct billing or billing-on-behalf-of (BOBO) information may be provided by a carrier for display on the user interface screen 1000. BOBO billing allows a carrier to transfer money to an account for the owner of the wireless device 110 and this information may be displayed on the user interface screen 1000. This information may be automatically presented or presented in response to a query. This type of shared billing information may be provided to the user of the wireless device 110 and provide further incentive to make the wireless device 110 available to others for network connectivity. Billing credits could be shared by token or direct deposit to an account and may be split in any fashion acceptable to all parties involved.

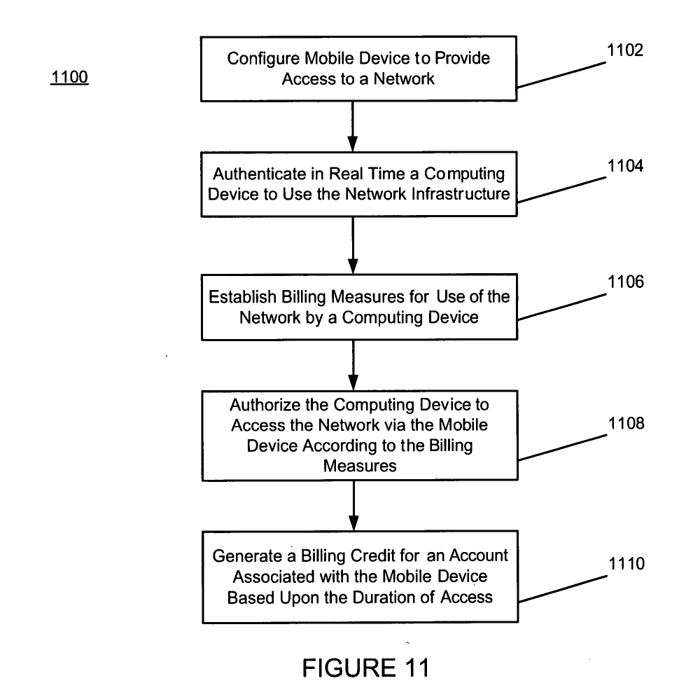

FIG. 11 illustrates an exemplary process 1100 for providing mobile network access. A mobile device is configured to provide access to a network infrastructure (step 1102). Authentication is performed in real time for a computing device to use the network infrastructure (step 1104). Billing measures are established for use of the network infrastructure by a computing device (step 1106). The computing device is authorized to access the network infrastructure via the mobile device in accordance with the billing measures (step 1108). A billing credit is generated for an account associated with the mobile device based upon the duration of the access to the network infrastructure by the computing device (step 1110).

An implementation that allows third parties (strangers) to establish a communication session that passes through a wireless device 110 to enable a client computing device 114, such as a laptop to access a network such as the Internet 104 may be implemented with an AAA server and billing system (AAA stands for the actions of Authentication, Authorization and Accounting). The WLAN HTML may be converted into traditional Call Detail Record (CDR) formatting used by a particular wireless service provider. While not essential, it may be useful to meter for bytes of traffic at the point of contact at the wireless service provider as the packets are apt to be repackaged before entry into the Internet 104 which is apt to alter the number of bytes that are transferred from the wireless service provider to the Internet 104 from the number of bytes that passed through the wireless device 110 as the amount of overhead will not be the same once the packets are repackaged.

While this service could be hosted by a wireless service carrier, it could alternatively be hosted by a MVNO which is a company that does not own any licensed frequency spectrum, but resells wireless services under their own brand name, using the network of another mobile phone operator.

While the Internet 104 is the network of choice for many users and the network mentioned in many instances in the description of uses of this disclosure, the disclosure is not limited to uses connecting to the Internet 104. Another network independent of the Internet 104 could be accessed in keeping with the teachings of the present disclosure. Likewise, the teachings of the present disclosure could be used to connect to a company network (e.g., an intranet or extranet) which is limited to specific users but could, in turn, provide access to the Internet 104.

While the present disclosure has been described as taking advantage of features found in networks using Third Generation Cellular Device Technology (3G), the teachings of the present disclosure can be implemented by one of skill in the art in analogously enabled alternatives to 3G or to replacements to the 3G system. It is further noted that the present disclosure also works on data networks prior to 3G, but at slower speeds due to certain limitations of such data networks.

Functionality of Cellular Device—Another implementation of the present disclosure may seek to have the wireless device 110 act as a bridge for traffic so that the wireless device 110 is not concerned with the safe receipt of packets related to communication links between a client computing device 114, such as a laptop, and the Internet 104. Thus it would be up to the equipment upstream from the wireless device 110 and the client computing device 114 to acknowledge receipt of packets and resend packets if no acknowledged receipt is received within a reasonable period of time.

Another implementation of the present disclosure may seek to have the wireless device 110 route the packets for communication sessions between a laptop and the Internet 104. This may include the issuance of acknowledgements for packets and the resending of stored packets if the wireless device 110 doesn't receive acknowledgement of the safe receipt of a packet from the laptop or upstream device.

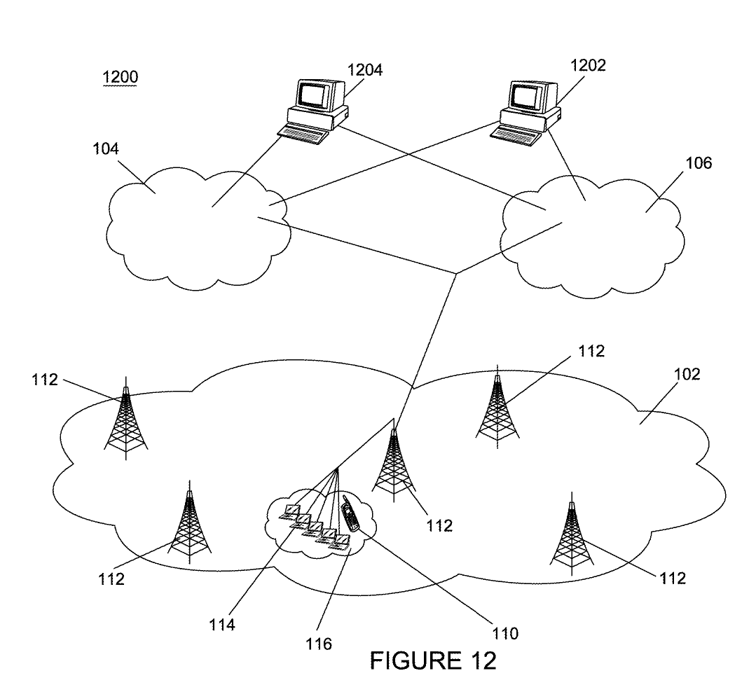

FIG. 12 illustrates an alternative exemplary network environment 1200 according to an implementation of the subject matter described herein. One of skill in the art will recognize that the tasks associated with the server 108 may be divided between two servers. An authorization server 1202 provides authorization for communication to the network infrastructure. A billing server 1204 connected to the network infrastructure may interact with the authentication server 1202.

If authenticated, one or more metrics characterizing the connection session may be communicated to the billing server 1204 as the billing server 1204 has a billing relationship with the user of the client computing device 114 (or some entity associated with the user such as the user's employer, parents, et cetera). This division of tasks between an authentication server 1202 and the billing server 1204 may be useful to allow a user of the client computing device 114 to access the network infrastructure through the wireless device 110 associated with a service provider unaffiliated with the user of the client computing device 114. Thus, while the authentication server 1202 for the service provider serving the user of the wireless device 110 may be able to bill other users of that service provider for access to the network infrastructure (such as the Internet), the authentication server 1202 may not be able to bill a user of the client computing device 114 that does not have any relationship with that service provider.

This model expands the number of people that may access the network infrastructure through a particular wireless device 110 as one may access the Internet through any wireless device 110 associated with a service provider that in turn has a relationship with another service provider associated with the user of the client computing device 114.

One of skill in the art will recognize that a single server may serve the roles of the authentication server 1202 and the billing server 1204 for some sessions, the authentication server 1202 and not the billing server 1204 for other sessions, and the billing server 1204 and not the authentication server 1202 for other sessions depending upon the relationships and connection routes associated with the various sessions.

One of skill in the art will appreciate that the concept of allowing access for a user to become authenticated could be expanded to include allowing a user of the client computing device 114 without a previously established billing account with a service provider to establish a connection for the purpose of creating a billing account. This could be implemented as either allowing the user of the client computing device 114 to establish a billing account with the service provider for the wireless service associated with the wireless device 110 being accessed by the client computing device 114 or a different service provider accessed through the network infrastructure and unrelated to the service provider for the wireless service for the wireless device 110.

One of skill in the art will appreciate that software instructions may be stored in a variety of ways. While the term “firmware” might seem to imply some third alternative other than software and hardware, firmware is a type of software that may be embedded into a hardware device, often on a Read-Only Memory (ROM) of one type or another.

While the use of a laptop in the examples given above helps illustrate the use of the present disclosure, teachings of the present disclosure may serve other client computing devices 114, such as workstation computers, that are not mobile laptops. Other client computing devices 114 that benefit from a high bandwidth connection to the Internet 104 or other network may benefit from the present disclosure and should be included in the scope of claims based on this disclosure unless explicitly excluded.

One of skill in the art will recognize that some of the alternative implementations set forth above are not universally mutually exclusive and that in some cases additional implementations can be created that employ aspects of two or more of the variations described above. Likewise, the present disclosure is not limited to the specific examples or particular embodiments provided to promote understanding of the various teachings of the present disclosure. Moreover, the scope of the claims which follow covers the range of variations, modifications, and substitutes for the components described herein as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

Glossary

| | |
|---|---|
| 3G | Third Generation Cellular Device Technology |
| 802.11 | 802.11 is a set of standards for wireless local area network (WLAN) computer |
| | communications, developed by the IEEE LAN/MAN Standards Committee. |
| 802.1X | The 802.1X is a standard intended to enhance the security of wireless local area |
| | networks (WLANs) that follow the 802.11 standard. 802.1X provides an |
| | authentication framework for WLANs, allowing a user to be authenticated by a |
| | central authority. The actual algorithm that is used to determine whether a user is |
| | authentic is left open and multiple algorithms are possible. |
| | 802.1X uses an existing protocol, the Extensible Authentication Protocol (EAP, |
| | RFC 2284 and its successors), that works on Ethernet, Token Ring, or WLANs, for |
| | message exchange during the authentication process. |
| | In a WLAN with 802.1X, a user (known as the supplicant) requests access to an |
| | access point (known as the authenticator). The access point forces the user |
| | (actually, the user's client software) into an unauthorized state that allows the client |
| | to send only an EAP start message. The access point returns an EAP message |
| | requesting the user's identity. The client returns the identity, which is then |
| | forwarded by the access point to the authentication server, which uses an algorithm |
| | to authenticate the user and then returns an accept or reject message back to the |
| | access point. Assuming an accept was received, the access point changes the |
| | client's state to authorized and normal traffic can now take place. |
| | The authentication server may use the Remote Authentication Dial-In User Service |
| | (RADIUS), although 802.1X does not specify it. |
| | Source Andrew Livesley |
| | http://searchmobilecomputing.techtarget.com/sDefinition/0,,sid40_gci787174,00.html |
| AAA | Authentication, Authorization and Accounting |
| ADSL | Asymmetric Digital Subscriber Line (ADSL) is a form of DSL, a data |
| | communications technology that enables faster data transmission over copper |
| | telephone lines than a conventional modem can provide. |
| CDR | Call Detail Record (CDR) (also Call Detail Recording) |
| EAP | Extensible Authentication Protocol |
| HDSPA | High Speed Downlink Packet Access (HSDPA) is a packet-based data service in |
| | the UMTS network, which allows a faster download speed than traditional UMTS. |
| HTML | HyperText Markup Language (HTML) is a common markup language for the |
| | creation of web pages |
| MVNO | A mobile virtual network operator. |
| PSTN | Public Switched Telephone Network. |
| T1/E1 | T1 is often used to mean any data circuit that runs at the original 1.544 Mbit/s line |
| | rate. Originally T1 was a specific implementation of the T-carrier signaling |
| | scheme devised by Bell Laboratories. The T-carrier signaling scheme is a widely |
| | used in North America and Japan to transmit voice and data between devices. E1 |
| | is used in place of T1 outside of North America and Japan. |
| UAM | Universal Access Method |
| UMTS | Universal Mobile Telecommunications System |
| W- | W-CDMA (Wideband Code Division Multiple Access) is a type of 3G cellular |
| CDMA | network. W-CDMA is the higher speed transmission protocol used in the Japanese |
| | FOMA system and in the UMTS system, an advanced 3G system, designed as a |
| | replacement for the ageing 2G GSM networks deployed worldwide. |
| | More technically, W-CDMA is a wideband spread-spectrum mobile air interface |
| | that utilizes the direct sequence Code Division Multiple Access signaling method |
| | (or CDMA) to achieve higher speeds and support more users compared to the older |
| | TDMA signaling method of GSM networks. W-CDMA is a competitor to |
| | CDMA2000. |
| WEP | Wired Equivalent Privacy (WEP) |
| WFA | Wi-Fi Alliance--a global, non-profit organization with the goal of driving the |
| | adoption of a single worldwide-accepted standard for high-speed wireless local |
| | area networking. See http://www.wi-fi.org/about_overview.php |
| WLAN | Wireless Local Area Network |
| WPA | Wi-Fi Protected Access (WPA) is a security standard for users of computers |
| | equipped with Wi-Fi wireless connection |

What is claimed is:

1. A method for providing mobile network access, comprising:
configuring a wireless device to provide access to a network infrastructure;
authenticating in real time at least one computing device to use the network infrastructure;
establishing billing measures in real time for use of the network infrastructure by the at least one computing device;
authorizing the at least one computing device to access the network infrastructure via the wireless device in accordance with the billing measures; and
generating a billing credit for an account associated with the wireless device based upon a set of at least one metric characterizing the access to the network infrastructure by the at least one computing device.

2. The method of claim 1 wherein configuring the wireless device to provide the access to the network infrastructure further comprises executing an application on the wireless device to communicate with the at least one computing device and a server to provide the access to the network infrastructure.

3. The method of claim 1 wherein establishing the billing measures in real time for use of the network infrastructure by the at least one computing device further comprises communicating account identification information to a server to identify a billing account for the at least one computing device.

4. The method of claim 3 wherein authorizing the at least one computing device to access the network infrastructure via the wireless device in accordance with the billing measures further comprises receiving an indication from the server that the at least one computing device is authorized to access the network infrastructure.

5. The method of claim 1 wherein generating the billing credit for an account associated with the wireless device based upon the set of at least one metric characterizing the access to the network infrastructure by the at least one computing device further comprises sending the set of at least one metric characterizing the access to the network infrastructure by the at least one computing device to a server.

6. A wireless device for providing mobile network access, comprising:
an application adapted to provide access to a network infrastructure;
a memory adapted to store the application; and
a processor adapted to:
execute the application from the memory to configure the wireless device to provide the access to the network infrastructure; and
utilize the application to:
authenticate in real time at least one computing device to use the network infrastructure;
coordinate with a server to establish billing measures in real time for use of the network infrastructure by the at least one computing device; and
authorize the at least one computing device to access the network infrastructure via the wireless device in accordance with the billing measures.

7. The wireless device of claim 6 further comprising a radio frequency (RF) interface and a wireless network radio front end, and wherein the processor is further adapted to communicate via the wireless network radio front end with the at least one computing device and via the RF interface to a server to provide the access to the network infrastructure.

8. The wireless device of claim 7 wherein the processor is further adapted to communicate identification information associated with the at least one computing device to the server in real time via the RF interface.

9. The wireless device of claim 6 further comprising a radio frequency (RF) interface and wherein the processor is further adapted to communicate account identification information to a server via the RF interface to identify a billing account for the at least one computing device.

10. The wireless device of claim 9 wherein the processor is further adapted to receive an indication from the server via the RF interface that the at least one computing device is authorized to access the network infrastructure.

11. The wireless device of claim 6 further comprising a radio frequency (RF) interface and wherein the processor is further adapted to send at least one data quantity associated with the access to the network infrastructure by the at least one computing device to a server via the RF interface.

12. A system for providing mobile network access, comprising:
a wireless device adapted to:
provide access to a network infrastructure; and
authenticate in real time at least one computing device to use the network infrastructure; and
a server adapted to, in response to the authentication of the at least one computing device:
establish billing measures in real time for use of the network infrastructure by the at least one computing device;
authorize the at least one computing device to access the network infrastructure via the wireless device in accordance with the billing measures; and
generate a billing credit for an account associated with the wireless device based upon a set of at least one metric characterizing the access to the network infrastructure by the at least one computing device.

13. The system of claim 12 wherein the wireless device further comprises a radio frequency (RF) interface and a wireless network radio front end, and wherein the wireless device is further adapted to communicate via the wireless network radio front end with the at least one computing device and via the RF interface to the server to provide the access to the network infrastructure.

14. The system of claim 13 wherein the wireless device is further adapted to communicate identification information associated with the at least one computing device to the server in real time via the RF interface.

15. The system of claim 12 wherein the wireless device further comprises a radio frequency (RF) interface and is further adapted to communicate account identification information to the server via the RF interface to identify a billing account for the at least one computing device.

16. The system of claim 15 wherein the wireless device is further adapted to receive an indication from the server via the RF interface that the at least one computing device is authorized to access the network infrastructure.

17. The system of claim 12 wherein the wireless device further comprises a radio frequency (RF) interface and wherein the processor is further adapted to send at least one data quantity associated with the access to the network infrastructure by the at least one computing device to the server via the RF interface.

18. The system of claim 12 wherein the wireless device is further adapted to provide an indication of a number of active connections via a user interface of the wireless device.

19. The system of claim 12 wherein the wireless device is further adapted to provide identifying information for the at least one computing device via a user interface of the wireless device.
